(19) United States
(12) Patent Application Publication
(10) Pub. No.: US 2026/0270917 A1
(43) Pub. Date: Sep. 10, 2026

(54) CALL CONTROL FUNCTION RESTORATION PROCESS

(71) Applicant: T-MOBILE INNOVATIONS LLC, Overland Park, KS (US)

(72) Inventors: Rahul Amin, Issaquah, WA (US); Rushabhkumar Dahyabhai Patel, Newcastle, WA (US); Joel Lee Arends, Renton, WA (US)

(21) Appl. No.: 19/072,515

(22) Filed: Mar. 6, 2025

(51) Int. Cl. H04W 60/04; H04L 65/1016; H04L 65/1069

(52) U.S. Cl. CPC H04W 60/04; H04L 65/1016; H04L 65/1069

(57) ABSTRACT

Systems, methods, and software are disclosed herein for restoration of a call controller functionality of a wireless network. In one example, a method of operating a wireless network includes receiving a request from an IMS core of the wireless network for a new assignment of a call controller for an IMS registration of a UE on the wireless network. In response to the request, performing an update of a cache of call controllers is performed. The method further includes establishing a new network session for the UE on the wireless network using a second call controller from the updated cache of call controllers.

### TECHNICAL FIELD

Aspects of the disclosure are related to the field of wireless communication networks, particularly restoration of control session control functions for IMS service.

### BACKGROUND

In an Internet Protocol Multimedia Service (IMS) network, a user equipment (UE) registers for IMS services for real-time communications such as voice calls and video calls. During an IMS session, the Proxy Call Session Control Function (P-CSCF) of an IMS core hosting the IMS service anchors the IMS session, performing such tasks as facilitating signaling and call setup and maintaining a UE’s IMS registration state. As such, if the P-CSCF holding a subscriber's IMS registration fails, the UE will be unable to place or receive calls.

To recover from such a failure, the IMS session may be released and the UE prompted to reattach to the network. However, during this process, the UE may receive the same failed P-CSCF IP address along with other available P-CSCF addresses in the Protocol Configuration Options (PCO). As a result, there is a high probability that the UE will attempt to re-register with the failed P-CSCF before timing out. Indeed, the UE may make multiple attempts to re-register with the failed P-CSCF before trying another P-CSCF in the PCO, prolonging the service outage up to 150 seconds or more. This delay in successful registration can lead to network quality degradation and negatively impact the customer experience.

### OVERVIEW

Technology is disclosed herein for restoring a call control functionality after failure for wireless communication networks in various implementations. In one example, a computing apparatus comprises one or more computer readable storage media, one or more processors operatively coupled with the one or more computer readable storage media and program instructions stored on the one or more computer readable storage media that, when executed by the one or more processors, direct the computing apparatus to act as follows. The computing apparatus establishes an Internet Protocol Multimedia Service (IMS) registration for a UE for network service hosted by a wireless network with the network service anchored by a call controller of the IMS core. The computing apparatus receives a request from IMS core for an assignment of a new call controller for the IMS registration. In response to the request, the computing apparatus performs an update of a cache of call controllers and establishes a new network session for the IMS registration anchored by the new call controller from the updated cache of call controllers.

In another example, a method of operating a wireless network includes, by a session manager of the wireless network, establishing an Internet Protocol Multimedia Service (IMS) registration of a user equipment (UE) for network service hosted by an IMS core of the wireless network, wherein the network service is anchored by a call controller of the IMS core. The method continues with the session manager receiving, from IMS core, a request for an assignment of a new call controller for the IMS registration. In response to the request, the session manager performs an update of a cache of call controllers and establishes a new network session for the IMS registration anchored by the new call controller from the updated cache of call controllers.

In yet another example of the technology disclosed herein, a method of operating a wireless network includes receiving a request from the IMS core of the wireless network to update an assignment of a call controller of the IMS registration for the UE. In response to the request, the method continues with querying a datastore for available call controllers and updating of a cache of call controllers based on the query. The method continues with establishing a new network session for the UE on the wireless network anchored by the call controller from the updated cache of call controllers.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational scenario for restoration of call control functionality in a wireless network in an implementation.

FIG. 2 illustrates a process for restoring call control functionality in a wireless network in an implementation.

FIG. 3 illustrates an operational scenario for restoring call control functionality in a 5G network after failure in an implementation.

FIGS. 4A and 4B illustrate a workflow for restoring call control functionality in a 5G network in an implementation.

FIG. 5 illustrates an operational scenario for restoring call control functionality in an LTE network in an implementation.

FIGS. 6A and 6B illustrate a workflow for restoring call control functionality in an LTE network in an implementation.

FIG. 7 illustrates an operational architecture of a wireless communication network in an implementation.

FIG. 8 illustrates a systems architecture of a wireless communication network in an implementation.

FIG. 9 illustrates another operational architecture of a wireless communication network in an implementation.

FIG. 10 illustrates another systems architecture of a wireless communication network in an implementation.

FIG. 11 illustrates a computing system suitable for implementing the various operational environments, architectures, processes, scenarios, and sequences discussed below with respect to the other Figures.

### DETAILED DESCRIPTION

Although the descriptions provided herein may be in the context of certain radio access technologies, networks, and network topologies, such as 5G-NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

Various implementations are disclosed herein for restoring call control functionality of an Internet Protocol (IP) Multimedia Service (IMS) registration of a user equipment (UE) in the event of a loss of a call control functionality in the IMS core. In an exemplary scenario, a UE attaches to a wireless communication network for IMS service, such as a voice over IP (VoIP) or voice over New Radio (VoNR) call. During the call, a call session controller (e.g., a P-CSCF) fails. When the call session controller fails, the failure, such as a heartbeat timeout, is detected by domain name server (DNS) of the network. In parallel with the failure detection by the DNS, the IMS core hosting the failed call session controller sends a request for controller restoration to a subscriber database function of the network. Having received the restoration request, the subscriber database prompts the session manager of the IMS registration to immediately query the DNS to update its cache of available (working) call session controllers and overwrite or purge its existing list or cache of call session controllers including the failed controller. Based on the DNS failing to receive a heartbeat from the failed controller, the DNS will not include the failed controller in its response to the session manager. The session manager also signals to the UE to end the current network session and request a new one.

When the UE requests a new network session with the network, the session manager supplies the IP addresses of other call session controllers from the newly updated cache. Because the newly updated cache will most likely not include the failed call session controller, the risk of the session manager supplying the failed controller to the UE and the UE attempting to reconnect to the failed controller is reduced and a corresponding degradation of the user experience mitigated. Thus, IMS service can be more quickly restored to the UE based on a failover process which includes an on-demand query for available, functioning call session controllers.

In an exemplary scenario in a 5G-NR network, the session manager may be a Session Management Function (SMF), and the failed call session controller includes a P-CSCF of the IMS core. To prompt the SMF of the IMS registration to update its cache of available P-CSCFs in the event of the detected failure, the SMF receives a P-CSCF restoration notice from the Unified Data Management (UDM) which includes a cause code or flag for P-CSCF restoration. (The UDM sends the request in response to receiving a request from the IMS core for a P-CSCF restoration.) Based on the request with the cause code, the SMF queries the DNS for an updated list of available P-CSCFs. Thus, the SMF immediately updates its list of available P-CSCFs rather than waiting for the next update cycle or expiration of a time-to-live (TTL) of the cache to perform an update.

Continuing with the exemplary scenario in the 5G-NR network, when the SMF receives the P-CSCF restoration notice from the UDM, the SMF also sends a message to the Access and Mobility Management Function (AMF) to release the Protocol Data Unit (PDU) session of the IMS registration. In turn, the AMF sends a PDU session release message including a reactivation request to the UE. The UE then returns a session release completion message followed by a request to create a new PDU session.

In an exemplary scenario in an LTE network, the session manager may be a control plane gateway (CP-GW) which includes control plane elements of a Serving Gateway (SGW-C) and a Packet Data Network Gateway (PGW-C), and the call session controller includes a P-CSCF of the IMS core. To prompt the CP-GW of the IMS registration to update the cache of available P-CSCFs in the event of a detected failure, the CP-GW receives a request to delete the IMS session from the mobility management entity (MME) of the IMS registration. The request from the MME includes a cause code or flag for P-CSCF restoration. Based on the request with the cause code, the CP-GW immediately queries the DNS for an updated list of available P-CSCFs rather than waiting for the next update cycle or expiration of a time-to-live (TTL) for the cache.

In the LTE network, the request to the MME is based on the IMS core transmitting a P-CSCF restoration request to a Home Subscriber Service (HSS) of the IMS registration. In response to the request from the IMS core, the HSS sends a request to the MME to update its subscriber database with respect to the failed P-CSCF. The request from the HSS triggers the MME to send the session deletion request to the CP-GW with the P-CSCF restoration flag. The MME also sends a request to the UE to delete the bearer along with a reactivation request. The UE in response sends a request to connect to the MME to establish a new Packet Data Network (PDN) connection.

Technical effects of the technology disclosed herein include an improved user experience whereby when an IMS call fails due to the loss of P-CSCF functionality. In particular, when the UE attempts to register for a new IMS session, the risk of connecting through the failed P-CSCF is significantly reduced or eliminated. Thus, having experienced a failed call, the user or subscriber is not subjected to repeated, time-consuming, failed attempts at re-establishing the call. Moreover, rather than devising a new messaging protocol for pushing an update about the failed controller to the session manager or waiting for the session manager to perform its scheduled update, the session manager is instead prompted to perform an on-demand purge and renewal of its cache of available call controller functions and to initiate a process of establishing a new PDU/PDN session.

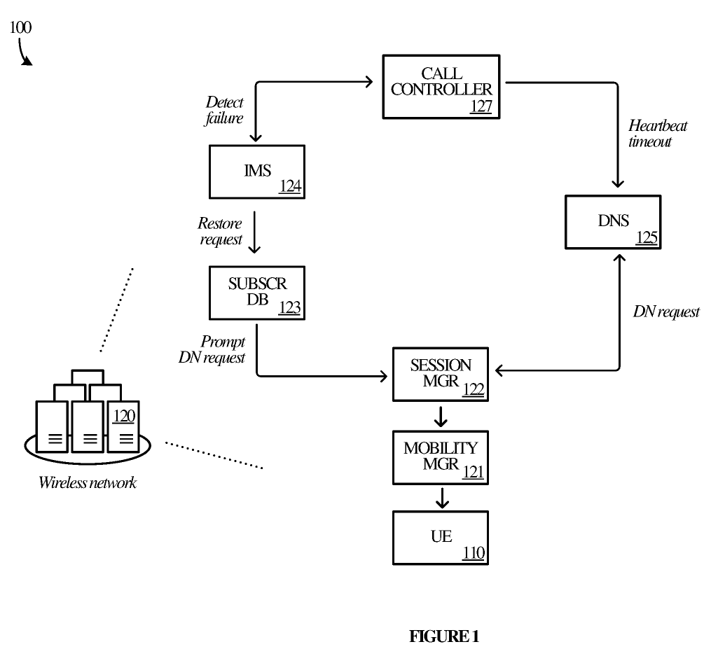

Turning now to the Figures, FIG. 1 illustrates operational environment 100 for restoring call control functionality for an IMS registration for wireless communication networks in an implementation. Operational environment 100 includes UE 110 and wireless network 120 including mobility manager 121, session manager 122, subscriber database 123, IMS core 124, DNS 125, and call controller 127.

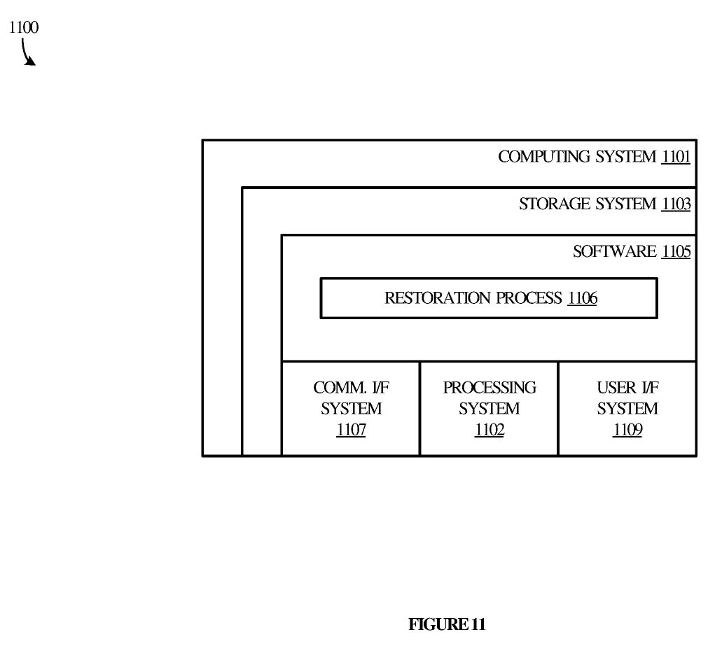

User equipment 110 is representative of a device, such as a smartphone, computer, sensor, controller, radio, and/or some other user apparatus, with processing circuitry for wireless communication with wireless network 120 using protocols such as Fifth Generation New Radio (5GNR), 5G Advanced, LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). User equipment 110 can include devices such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which computing system 1101 in FIG. 11 is broadly representative.

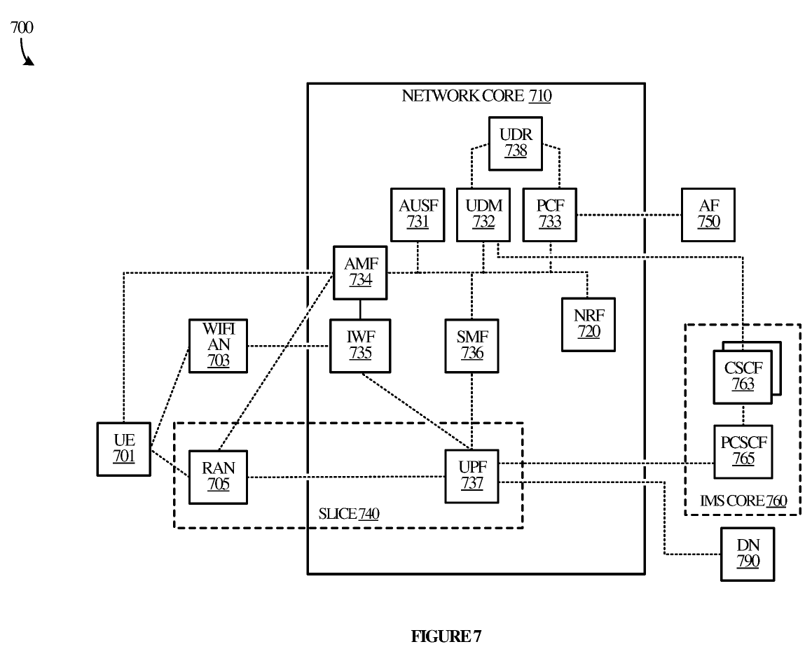

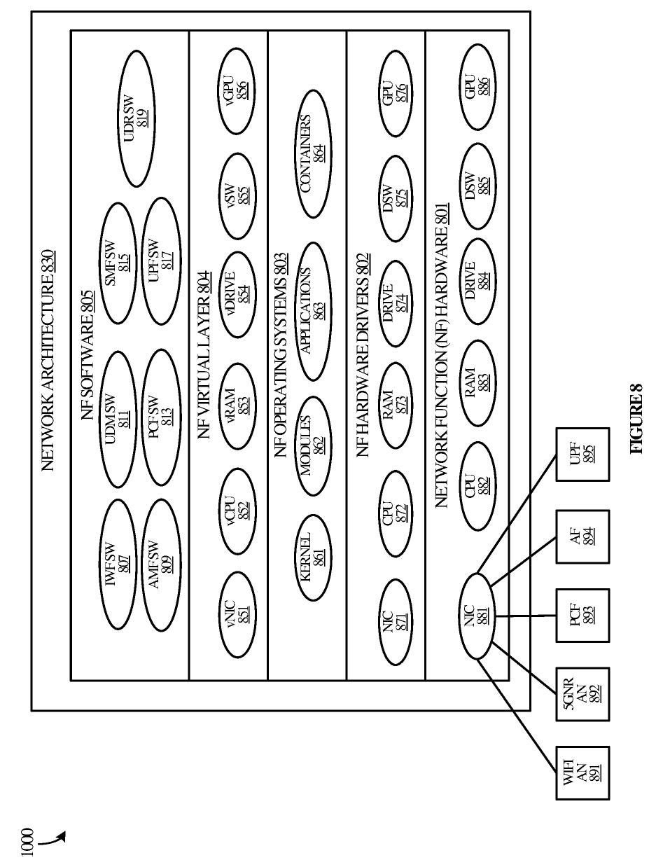

Wireless network 120 is representative of a communication network capable of using a Fifth Generation New Radio (5G-NR), LTE, 6G, or other protocol to communicate with computing devices such as user equipment 110. In some implementations, wireless network 120 is representative of a service-based architecture (SBA) which includes network functions which constitute the control plane and user plane of a wireless communication network core, of which network core 710 of FIG. 7 and network architecture 830 of FIG. 8 or network core 920 and network architecture 1020 are examples. In some implementations, wireless network 120 is representative of an evolved packet core (EPC) architecture which uses dedicated interfaces between network functions to manage network access, mobility, and data transmissions. In some scenarios, wireless network 120 is a hybrid architecture including elements of SBA and EPC architectures, such as a 5G Non-Standalone (5GNSA) architecture.

The network functions of wireless network 120 are implemented on one or more suitable computing devices, of which computing device 1101 of FIG. 11 is representative. Examples of suitable computing devices include server computers, blade servers, and the like. The network elements of wireless network 120 may be implemented in the context of one or more data centers in a co-located or distributed manner, or in some other arrangement.

Session manager 122 is representative of a functionality or service implemented in software or hardware for establishing, modifying, and releasing user sessions within a wireless network, including managing IP address allocation, enforcing policy control, and coordinating with user plane functions to facilitate data flow routing. In a 5G network, session manager 122 may be an SMF; in an LTE network, the function of the session manager 122 may be implemented as or within an SGW, a PGW, or the combined functionality of an SGW and PGW (e.g., CP-GW).

Mobility manager 121 is representative of a functionality or service implemented in software or hardware for controlling the exchange of the user data from a user device, such as UE 110, over a radio access node based on a subscriber profile of the device. For example, mobility manager 121 may handle the initial attachment of a user device, manage the mobility of the device, and maintain context information for the device. In a 5G network, mobility manager 121 may be an AMF; in an LTE network, mobility manager 121 may be an MME.

Subscriber database 123 is representative of a functionality or service implemented in software or hardware for storing, managing, and providing access to user-related data and subscription information. For example, subscriber database 123 may manage user subscription profiles, service data handling, and subscriber data handling. Subscriber database 123 may interact with a data repository (not shown) to manage the handling of subscriber session data, context information, subscriber profiles, and so on. In a 5G network, subscriber database 123 may be a UDM; in an LTE network, subscriber database 123 may be an HSS.

IMS core 124 is representative of an IMS-based communication system or platform for voice, video, messaging, and other real-time multimedia service over an IP network, including supporting session control, media negotiation, and policy enforcement for real-time communication (RTC) across various network environments.

DNS 125 is representative of a functionality or service implemented in software or hardware for translating domain names into Internet Protocol (IP) addresses, enabling other network functions to locate and connect to other network functions. DNS 125 may operate in conjunction with a Global Traffic Manager (GTM) to optimize traffic distribution across multiple data centers or network regions for enhanced performance, redundancy, and fault tolerance.

Call controller 127 is representative of a functionality or service implemented in software or hardware for managing and controlling a Session Initiation Protocol (SIP) session in an IMS network such as IMS core 124. Call controller 127 includes functionality for handling call setup, routing, and teardown, enforces policy and QoS requirements, and interacts with other IMS components for data traffic over IP networks. In some implementations, call controller 127 is a P-CSCF which serves a first point of contact for UEs such as UE 110, performing SIP signal compression, security enforcement, and Quality of Service (QoS) authorization while forwarding requests to other CSCF entities in IMS core 124.

In a brief operational scenario of operational environment 100, UE 110 attaches to wireless network 120 for IMS service, such as a voice over IP (VoIP), voice over New Radio (VoNR) call, video communication, Short Message Service (SMS), and the like. The IMS registration for the call is managed by session manager 122 and mobility manager 121. The IMS service for UE 110 connects through call controller 127.

During the call, call controller 127 fails. When call controller 127 fails, the failure is detected by DNS 125. For example, a heartbeat timeout is detected by a GTM of DNS 125. In parallel with the failure detection, IMS core 124 hosting call controller 127 sends a request for controller restoration to subscriber database 123 of wireless network 120. When subscriber database 123 receives the restoration request, subscriber database 123 prompts session manager 122 to immediately purge its existing cache of call controllers and query DNS 125 to update its static list or cache of available (working) call controllers. Having detected a failure at call controller 127, DNS 125 does not include call controller 127 in the information returned to session manager 122. In addition to refreshing its list or cache of available call controllers, session manager 122 signals to mobility manager 121 to terminate the current PDU/PDN session. Mobility manager 122 signals UE 110 to terminate the session and to reattach to wireless network 120.

When UE 110 attempts to reattach to wireless network 120, session manager 122 supplies references (e.g., IP addresses) of available call controllers that excludes (failed) call controller 127. For example, session manager 122 returns Protocol Configuration Option field (PCO) during the establishment of the new PDU/PDN session which includes one or more IP addresses of available call controllers based on the information received from DNS 125. UE 110 proceeds with reestablishing IMS service with wireless network 120 using a call controller selected from the PCO.

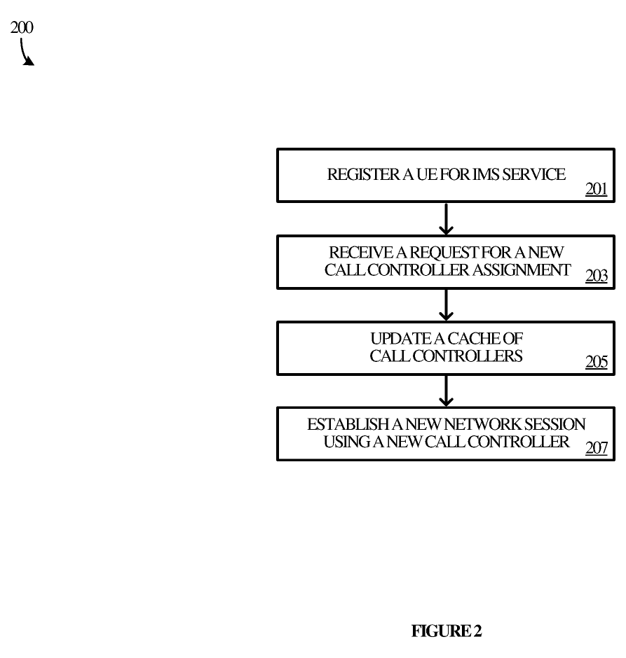

FIG. 2 illustrates a method of restoring call control functionality for an IMS registration for wireless communication networks in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In process 200, the computing device establishes an IMS registration for a UE for network service (step 201). In an implementation, the computing device, such as an SMF or CP-GW (i.e., control plane functionality of an SGW and/or PGW), establishes an IMS registration for carrying IMS data traffic (e.g., VoNR, VoLTE) for a UE on a wireless network, such as a 5G, LTE, or hybrid network. The network session for the IMS registration may be a PDN connection session or a PDU session. The network session is anchored by a call controller of the IMS core such as a P-CSCF. At some point during the current network session, an outage occurs at the call controller causing a disruption in the IMS signaling of the network session.

The computing device receives a request for a new call controller assignment for the IMS registration of the UE (step 203). In an implementation, the computing device receives a notification to update or refresh its cache of available call controllers from another network function of the current network session. The notification includes a flag or cause code which prompts the computing device to update its cache of available call control functions. In some cases, the computing device receives the request from a subscriber database which was notified of the outage by the IMS core. The notification from the subscriber database (e.g., UDM) includes a flag or cause code which causes the computing device to immediately initiate a DNS query for resolving one or more Fully Qualified Domain Names (FQDNs) of call control functions from a network DNS. In other cases, the computing device receives a notification to delete the current PDN connection session from a mobility manager (e.g., MME) of the wireless network; the request includes a flag or cause code triggering an immediate DNS query by the computing device to the DNS. The mobility manager issues the notification to the computing device based on receiving a request to update its datastore from the subscriber database (e.g., HSS).

In an implementation, the requests initiated by the subscriber database (to the computing device or to the mobility manager) are based on having received a request for a new call controller assignment from the IMS core. For example, the disruption in IMS signaling arising from the failure of the call control function may be detected by another function of the IMS core, such as a Serving Call Session Control Function (S-CSCF) or an Interrogating Call Session Control Function (I-CSCF). When the outage is detected at the IMS core, the IMS core notifies a subscriber database of the wireless network.

The computing device updates a cache of call control functions in response to the request (step 205). In an implementation, the computing device maintains a cache of previously resolved domain names or IP addresses of available or functioning call control functions of the IMS core to reduce the frequency of querying the DNS for such information. The computing device regularly updates the cache according to a TTL of the cache, e.g., every fifteen minutes, every hour; when the TTL expires, the computing device performs an update of the cache. In the event of the call control function failure, however, when the computing device is queried for a new call control function, the computing device performs an immediate or on-demand refresh of the cache which overwrites the current instance of the cache. The immediate refresh may be out-of-cycle with the normal or regular updates of the cache; stated another way, the immediate refresh is performed independent of the TTL or scheduled or timed updates of the cache. By performing an immediate refresh of the cache, a new instance of the cache is generated by persisting updated information to the cache which will exclude any references to the failed call control function.

To perform the immediate update of the cache, in an implementation, the computing device queries a datastore, such as a DNS, for (IP addresses of) available or functioning call control functions. In an implementation, to query the DNS, the computing device initiates an immediate query to resolve the FQDN of call controllers (e.g., P-CSCFs) to the DNS in response to the request, and the DNS returns an up-to-date list or accounting of IP addresses for the available call control functions which the computing device persists in its cache.

In an implementation, to return an up-to-date accounting of available call control functions, the DNS monitors multiple call control functions of the IMS core by means of a heartbeat mechanism to determine which call control functions are available for network sessions. The DNS independently detects the outage at the call control function based on an absence of a heartbeat from the device. When the DNS (or its GTM) fails to detect a heartbeat from the failed call control function, the DNS updates its datastore of available call control functions to remove, exclude, or otherwise disqualify the failed call control function. Thus, when prompted to provide an up-to-date accounting to the computing device, the information supplied by the DNS to the computing device omits the failed call control function.

In some scenarios, if the DNS does not detect the outage before the computing device is notified of it, the DNS may supply the failed call control function information to the computing device in response to the DNS query. However, the likelihood of the computing device receiving up-to-date information which includes the failed call control function is significantly reduced.

The computing device establishes a new network session using a new call control function selected from the updated cache (step 207). In an implementation, the computing device transmits a notification to the UE to release or deactivate its current network (e.g., PDU, PDN) session and to establish a new network session with the network. When the UE requests the new session, the computing device returns, in the PCO field of its response, IP addresses of call control functions from the refreshed cache. Because the refreshed cache is unlikely to include the failed call control function, the newly established network session is more likely to be carried by a functioning call controller of the IMS core, thereby significantly reducing the likelihood of a degradation of the user experience due by prolonging the failure of the IMS registration.

In various implementations, the request for a new call control function assignment may be based on a loss of functionality of the call control function. The loss of functionality may be due to a hardware or software failure at the device, for load balancing, for device maintenance or upgrade, or the like.

Referring again to FIG. 1, a brief example of process 200 as employed by elements of operational environment 100 follows. In operation, UE 110 registers with wireless network 120 for IMS service, such as a VoNR or VoLTE call. During the network session, call controller 127 hosting data traffic for the IMS service fails. Session manager 122 receives a request for a new call controller assignment for the IMS registration of UE 110. The request prompts session manager 122 to update or restore a cache of call control functions from another network function of wireless network 120, such as subscriber database 123 or mobility manager 121.

The request for the new assignment that is received by session manager 122 is based on a notification originating from IMS core 124 received by subscriber database 123. For example, in an SBA (e.g., 5G) network, session manager 122 may receive the request from subscriber database 123 based on a notification received by subscriber database 123 from IMS core 124. In another example, in an EPC (e.g., LTE) network, session manager 122 receives the request from mobility manager 121 based on a chain of notifications: IMS core 124 requests a new call controller assignment for the IMS registration from subscriber database 123; subscriber database 123 in turn notifies mobility manager 121 to update its database including a flag for P-CSCF restoration. Mobility manager 121 prompts session manager 122 to update the call controller assignment of the IMS registration based on the flag for P-CSCF restoration.

Upon receiving the request, session manager 122 initiates a DNS query for resolving one or more call controller FQDNs to DNS 125 to obtain a list of IP addresses of call control functions. DNS 125 returns the list which session manager 122 uses to update the cache. The list of call control functions that DNS 125 returns to session manager 122 is based on call control functions which DNS 125 has determined to be available or functioning. For example, DNS 125 may receive regular indications (e.g., heartbeats) from call control functions which indicate that the call control functions are working. When a call control function does not issue a heartbeat (e.g., a heartbeat timeout occurs), DNS 125 updates its own accounting of available call control functions to exclude the noncommunicative call control function. In this way, when session manager 122 queries DNS 125 for available call control functions, if/when DNS 125 determines that call controller 127 is noncommunicative, DNS 125 excludes call controller 127 from the information provided to session manager 121. Thus, the method by which DNS 125 becomes aware of the failure at call controller 127 is independent of the method by which subscriber database 123 and session manager 122 become aware of the failure at call controller 127.

Next, having received the up-to-date information of available call controllers, session manager 122 provides the IP address or domain name of the available call controllers to mobility manager 121. Mobility manager 121 in turn provides the connection information for the available call controllers to UE 110 for use in establishing a new network session.

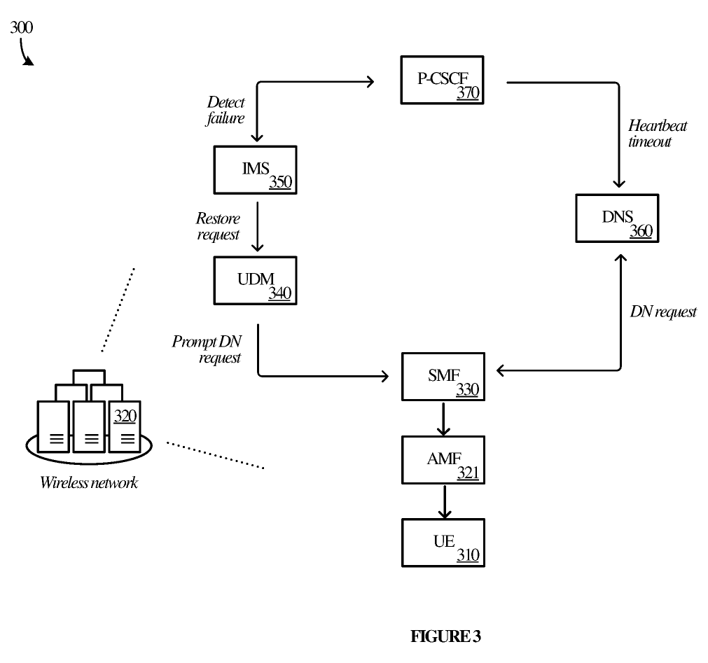

Turning now to FIG. 3, operational environment 300 of FIG. 3 depicts a process for restoring P-CSCF functionality for a UE on an SBA network in an implementation. Operational environment 300 includes UE 310 (of which UE 110 of FIG. 1 is representative) and wireless network 320. Wireless network 320 includes AMF 321 (of which mobility manager 121 is representative); SMF 330; UDM 340 (of which subscriber database 140 is representative); IMS core 350 (of which IMS core 150 is representative); DNS 360 (of which DNS 125 is representative); and P-CSCF 470.

Wireless network 320 is representative of a wireless communication network capable of using a Fifth Generation New Radio (5G-NR), 6G, or other protocol to communicate with computing devices such as user equipment 310. Wireless network 320 is representative of a service-based network architecture (SBA) which includes network functions which constitute the control plane and user plane of a wireless communication network core, of which network core 710 of FIG. 7 and network architecture 830 of FIG. 8 are examples.

SMF 330 is representative of a network function implemented in software or hardware for managing session establishment, modification, and release in a wireless network, including selecting user plane functions, enforcing policy and charging rules, handling PDU session management, and facilitating interactions with other core network functions such as UDM 340 and AMF 321. SMF 330 may be implemented on a computing system of which computing system 1101 of FIG. 11 is representative.

P-CSCF 370 is representative of a network function of an IMS core for handling SIP signaling in an IMS core, such as IMS core 350, including tasks such as processing IMS registration requests, routing call session signaling between UEs and the IMS core, enforcing policy and QoS rules, and securing IMS communications through authentication and integrity protection.

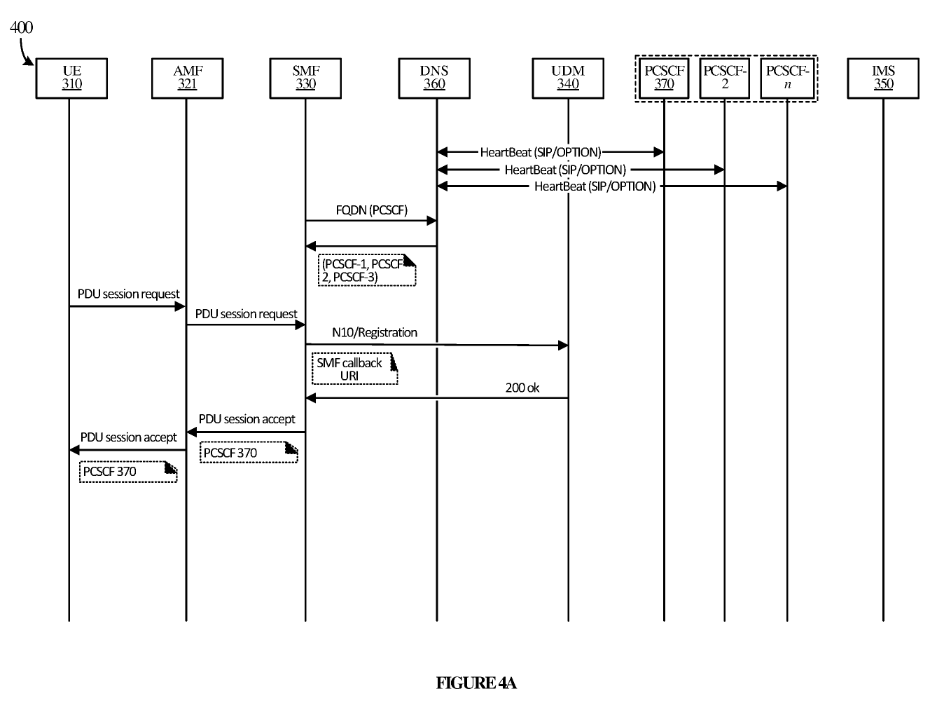

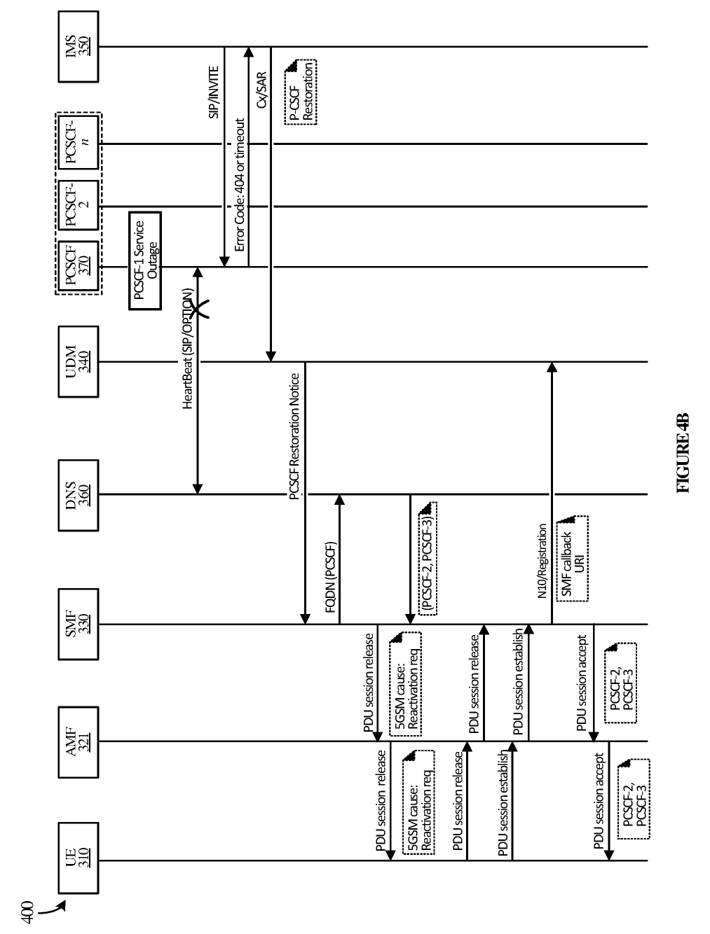

FIGS. 4A and 4B illustrate process 400 for restoring P-CSCF functionality for IMS service for a UE on a wireless network in an implementation, referring to elements of operational environment 300. In FIG. 4A, DNS 360 monitors a number of P-CSCFs of IMS core 350 using a heartbeat mechanism, where detecting a heartbeat (e.g., via GTM 365) from a P-CSCF indicates that the P-CSCF is available to be assigned to carry data traffic for an IMS registration. (As depicted in FIGS. 4A and 4B, some success response code signals of process 400 are omitted for clarity.)

Continuing with process 400, UE 310 registers with wireless network 320 for IMS service (e.g., VoNR) via IMS core 350. The request for a PDU session from UE 310 is received by AMF 321 and forwarded to SMF 330 which sends a registration notification to UDM 340 and receives subscriber-specific policies for UE 310. In some implementations, SMF 330 registers a Callback Uniform Resource Identifier (URI) in reference to the P-CSCF selected for the IMS session with UDM 340.

Continuing process 400 in FIG. 4B, an outage occurs at P-CSCF 370. DNS 360 detects the outage based on an absence of communication (e.g., heartbeat) from P-CSCF 370. IMS core 350 also detects the outage based on a signaling failure with P-CSCF 370, such as receiving an error code from P-CSCF 370 or failing to receive a response from P-CSCF 370.

In response to detecting the outage at P-CSCF 370, IMS core 350 sends a Server Assignment Request (SAR) request to UDM 340 including a flag or cause code for P-CSCF restoration. Upon receiving the request from IMS core 350, UDM 340 transmits a P-CSCF restoration notice to SMF 330. When SMF 330 receives the restoration notice from UDM 340, SMF immediately issues a DNS request to DNS 360 to receive an up-to-date list of available P-CSCFs, then supplies the IP addresses of available P-CSCFs for the IMS registration of UE 310. SMF 330 also signals AMF 321 (and, through AMF 321, UE 310) to release the current PDU session and establish a new PDU session. When UE 310 requests the establishment of a new (replacement) PDU session, SMF 330 returns the IP addresses or URLs Uniform Resource Locators) of available P-CSCFs (“P-CSCF-2, P-CSCF-3”) to UE 310 for the new session.

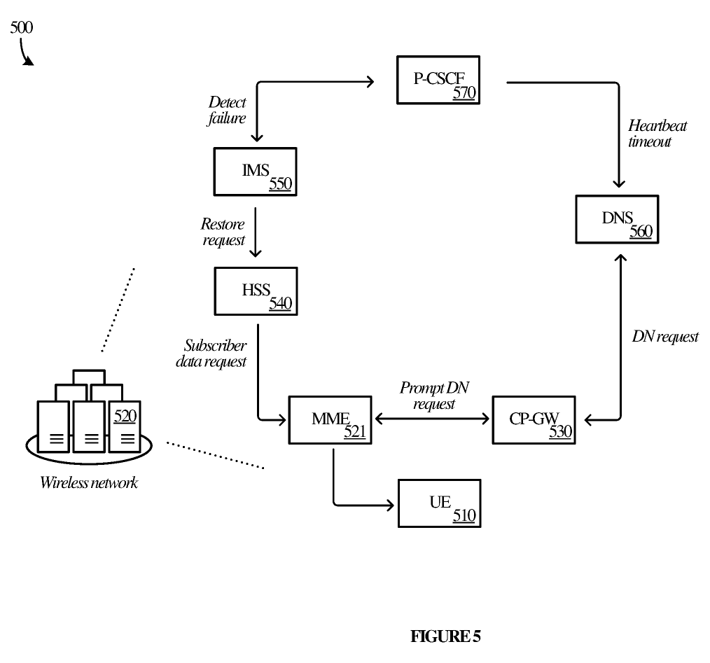

FIG. 5 illustrates operational environment 500 depicting a process for restoring P-CSCF functionality for a UE on an EPC network in an implementation. Operational environment 300 includes UE 510 (of which UE 510 of FIG. 1 is representative) and wireless network 520. Wireless network 520 includes MME 521 (of which mobility manager 121 is representative); CP-GW 530; HSS 540 (of which subscriber database 140 is representative); IMS core 550 (of which IMS core 150 is representative); DNS 560 (of which DNS 160 is representative); and P-CSCF 570 (of which P-CSCF 370 of FIG. 3 is representative).

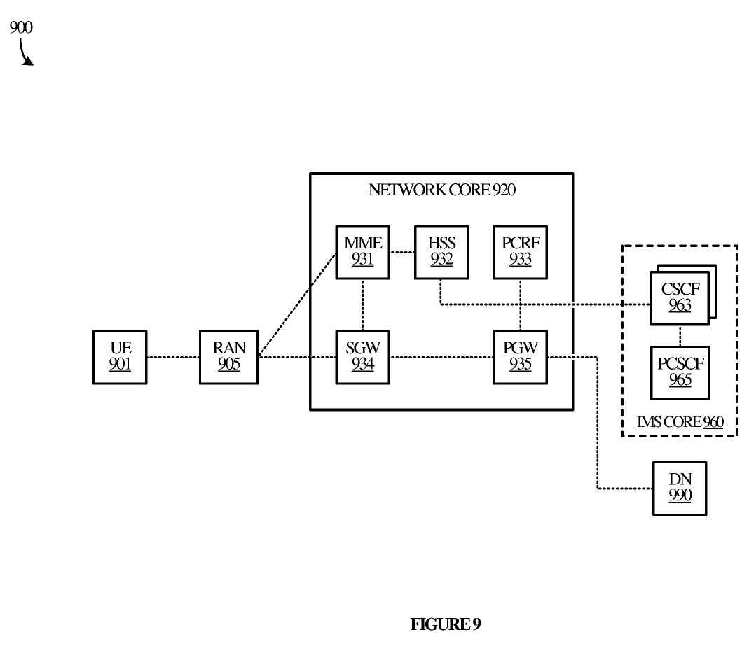

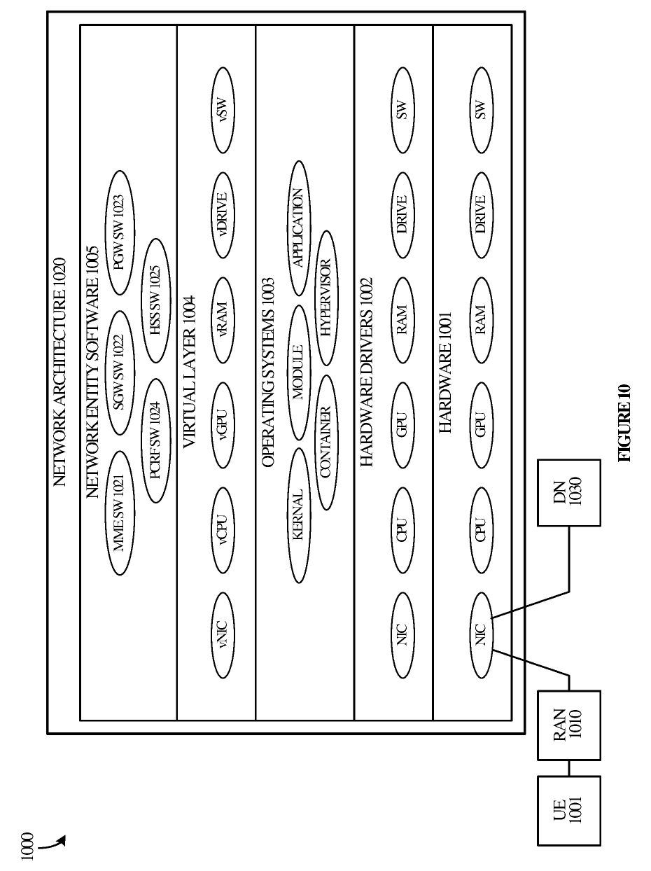

Wireless network 520 is representative of a communication network capable of using a 4G, LTE, or other protocol to communicate with computing devices such as user equipment 510. In some implementations, wireless network 520 is representative of an evolved packet core (EPC) architecture which uses dedicated interfaces between network functions to manage network access, mobility, and data transmissions of which network core 920 of FIG. 9 and network architecture 1020 of FIG. 10 are examples. In some scenarios, wireless network 520 is a hybrid architecture including elements of SBA and EPC architectures, such as a 5G Non-Standalone (5GNSA) architecture.

CP-GW 530 is representative of a network functionality or functionalities implemented in software or hardware for handling user plane traffic and session management within an EPC core, including establishing and managing PDN connection sessions, anchoring user traffic, and enforcing QoS policies in a wireless network such as wireless network 520. In an implementation, CP-GW 530 may include the control plane functionality of an SGW, the control plane functionality of a PGW, or the combined control plane functionalities of an SGW and PGW.

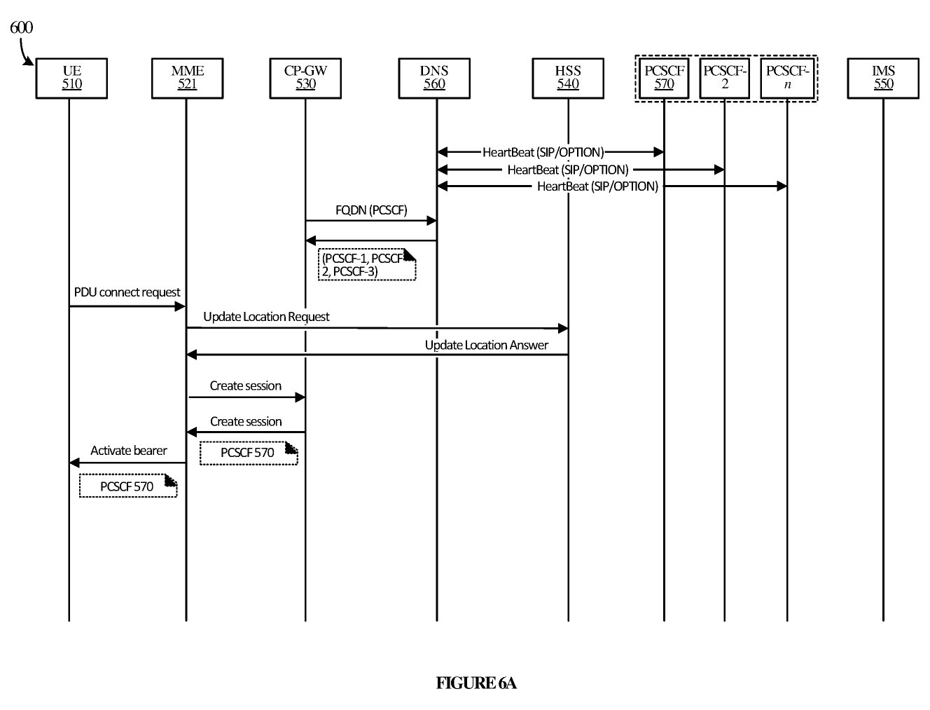

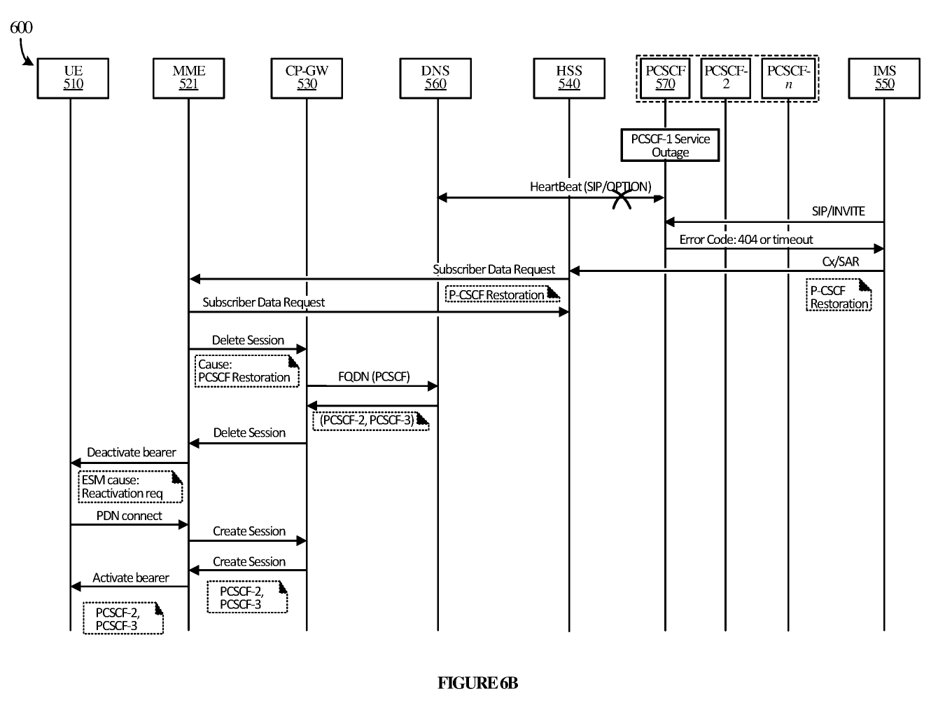

FIGS. 6A and 6B illustrate process 600 for restoring P-CSCF functionality for IMS service for a UE on a wireless network in an implementation, referring to elements of operational environment 500. In FIG. 6A, DNS 560 monitors a number of P-CSCFs of IMS core 550 using a heartbeat mechanism, where detecting a heartbeat from a P-CSCF indicates that the P-CSCF is available to be assigned to carry data traffic for an IMS registration. (As depicted in FIGS. 6A and 6B, some success response code signals of process 600 are omitted for clarity.)

Continuing with process 600, UE 510 registers with wireless network 520 for IMS service (e.g., VoLTE) via IMS core 550. The request for a PDN connection session from UE 510 is received by MME 521 which sends a location update for subscription retrieval to HSS 540 MME 521 also forwards to CP-GW 530 which assigns various network functionalities including P-CSCF 570 to the IMS registration of UE 510.

Continuing process 600 in FIG. 6B, an outage occurs at P-CSCF 570. DNS 560 detects the outage based on an absence of communication (e.g., heartbeat) from P-CSCF 570. IMS core 550 also detects the outage based on a signaling failure with P-CSCF 570, for example, by receiving an error code from P-CSCF 570 or failing to receive a response from P-CSCF 570.

In response to detecting the outage at P-CSCF 570, IMS core 550 sends a Server Assignment Request (SAR) request to HSS 540 including a flag or cause code for P-CSCF restoration. Upon receiving the request from IMS core 550, HSS 540 transmits an Insert Subscriber Data Request (IDR) to MME 521 including a flag or cause code for P-CSCF 570 restoration.

In response to receiving the request from the P-CSCF restoration notification from HSS 540, MME 521 sends a request to delete the current PDN connection session to SMF 330. The request to delete the current session includes a P-CSCF restoration flag or cause code. When CP-GW 530 receives the session delete request with P-CSCF restoration code from MME 521, CP-GW 530 immediately issues an DNS query for resolving P-CSCF FQDNs to DNS 560 to receive an updated list of available P-CSCFs and supplies the IP addresses of available P-CSCFs for the IMS registration of UE 510. CP-GW 530 also signals MME 521 (and, through MME 521, UE 510) to deactivate the bearer of the current PDN connection session and establish a new PDN connection. When UE 510 requests the establishment of a new (replacement) PDN session, CP-GW 530 returns the URLs of other available P-CSCFs (“P-CSCF-2, P-CSCF-3”) to UE 510 for the new session.

FIG. 7 illustrates exemplary wireless communication system 700 which hosts wireless communication services for User Equipment (UE) 701 according to the technology disclosed herein. Wireless communication system 700 depicts an example of wireless network 120 illustrated in FIG. 1 and wireless network 320 of FIG. 3. Wireless communication system 700 includes UE 701, Wifi Access Node (AN) 703, 5GNR RAN 705, network core 710, application function (AF) 750, IMS core 760, and data network (DN) 790. Network core 710 includes Interworking Function (IWF) 735, Access and Mobility Management Function (AMF) 734, Authentication Server Function (AUSF) 731, Unified Data Management (UDM) 732, Policy Control Function (PCFs 733, Session Management Function (SMF) 736, User Plane Function (UPF) 737, and Uniform Data Repository (UDR) 738. IMS core 760 includes call session control function (CSCF) 763 (which is representative of one or more I-CSCFs and S-CSCFs) and Proxy Call Session Control Function (P-CSCF) 765. IWF 735 includes non-3GPP IWFs (N3IWFs) for providing untrusted non-3GPP access to network data center 710, such as access via a non-cellular access network. In other examples, wireless communication network 700 may include different or additional elements than those illustrated in FIG. 7.

Network slice 740 is representative of an allocation of network resources of wireless communication system 700 for handling data plane traffic for UE 701 according to Quality of Service (QoS) policies enforced by SMF 736. DN 790 is representative of a data network, Internet access, third-party resource, or other endpoint of an end-to-end communication path from UE 701. For example, DN 790 may be another UE or an application server.

In an implementation, UE 701 communicates with network core 710 via 5G-NR access node 705 or Wifi access node 703. UE 701 requests access to DN 790 via the communication network of network core 710, e.g., via wireless network slice 740. SMF 736 receives the access request from AMF 734 and other network functions of the communication network which are enforcing various aspects of the access request from UE 701. SMF 736 receives policies or policy decisions from AUSF 731, UDM 732, PCF 733, and/or AMF 734.

FIG. 8 illustrates exemplary systems architecture 830 for a wireless communication system. For example, network architecture 830 may be implemented in wireless network 120 of FIG. 1 or wireless network 320 of FIG. 3. Network data center 830 includes network function (NF) software 805, network function virtual layer 804, network function operating systems 803, network function hardware drivers 802, and network function hardware 801.

Network function software 805 of network data center 830 includes software for executing various network functions: IWF software 807, AMF software 809, UDM software 811, PCF software 813, SMF software 815, UPF software 817, and UDR software 819. Other network function software, such as network repository function (NRF) software, are typically present but are omitted for clarity.

Network function virtual layer 804 includes virtualized components of network data center 830, such as virtual NIC 851, virtual CPU 852, virtual RAM 853, virtual drive 854, virtual software 855, and virtual GPU 856. Network operating systems 803 includes components for operating network data center 830, including kernels 861, modules 862, applications 863, and containers 864 for network function software execution. Network function hardware drivers 802 include software for operating network function hardware 801 of network data center 830, including network interface card (NIC) drivers 871 for network interface cards (NICs) 881, CPU drivers 872 for CPUs 882, RAM drivers 873 for RAM 883, flash/disk drive drivers 874 for flash/disk drives 884, data switch (DSW) drivers 875 for data switches 885, and drivers 876 for GPUs 886. Network interface cards 881 of network function hardware 801 include hardware components for communicating with Wifi access node 891, 5GNR access node 892, PCF 893, application server 894, and UPF 895.

FIG. 9 illustrates wireless communication network 900 which hosts wireless communication services for User Equipment (UE) 901 according to the technology disclosed herein. Wireless communication network 900 depicts an example of wireless network 120 illustrated in FIG. 1 and wireless network 520 of FIG. 5. Wireless communication network 900 includes UE 901, RAN 905, network core 920, IMS core 960, and data network 990. RAN 905 can include an LTE eNodeB cell. Network core 920 includes Mobility Management Entity (MME) 931, Home Subscriber Service (HSS) 932, Policy and Charging Rules Function (PCRF) 933, Serving Gateway (SGW) 934, and Packet Data Network Gateway (PGW) 935. SGW 934 and PGW 935 can include control plane and user plane elements which are not shown for clarity. IMS core 960 includes CSCF 963 and Proxy Call Session Control Function (P-CSCF) 965. CSCF 963 is representative of one or more call session control functions such as an Interrogating-CSCF (I-CSCF) and a Serving-CSCF (S-CSCF). In other implementations, wireless communication network 900 may include different or additional elements than those illustrated in FIG. 9.

In one example, UE 901 attaches to the wireless network of network core 910 via RAN 905. UE 901 sends a PDN connectivity request to MME 931, and MME 931 interacts with HSS 932 to authenticate and authorize UE 901 for wireless service. Upon successful authentication, MME 931 selects SGW 934 and PGW 935 to establish an EPS bearer for data communication. PGW 935 interfaces with PCRF 933 to apply the appropriate QoS and charging policies. To enable IMS services, such as a VoLTE call, PGW 935 provides connectivity to IMS core 960, where P-CSCF 965 is discovered via the DNS and DHCP procedures. UE 901 then registers with the IMS network by sending SIP REGISTER messages to the IMS core 960 via P-CSCF 965, which forwards the request to CSCF 963 for authentication and service provisioning. Once registration is complete, UE 901 can initiate a VoLTE call by sending a SIP INVITE message through the IMS signaling path, while the established dedicated bearers ensure the required QoS for real-time voice communication.

FIG. 10 illustrates network architecture 1020, a systems architecture for a wireless communication system. For example, network architecture 1020 may be implemented in wireless network 120 of FIG. 1 or wireless network 520 of FIG. 5. Network architecture 1020 can include a virtualized computing architecture such as a Network Function Virtualization Infrastructure (NFVI) but can include another computing architecture like a cloud computing network, a hybrid cloud network, and the like. Network architecture 1020 includes hardware 1001, hardware drivers 1002, operating systems 1003, virtual layer 1004, and network entity software 1005. Hardware 1001 includes Network Interface Cards (NICs), CPU, GPU, RAM, Flash/Disk Drives (DRIVE), and Data Switches (SW). Hardware drivers 1002 include software that is resident in the NIC, CPU, GPU, RAM, DRIVE, and SW. Operating systems 1003 include kernels, modules, applications, containers, hypervisors, and the like. Virtual layer 1004 includes vNIC, vCPU, vGPU, vRAM, vDRIVE, and vSW. Network entity software 1005 includes MME software (SW) 1021, SGW software 1022, PGW software 1023, PCRF software 1024, and HSS software 1025. Additional network entity software for HLR and DRA is typically present but is omitted for clarity. Network architecture 1020 may be located at a single site or be distributed across multiple geographic locations. The NIC in hardware 1001 is coupled to RAN 1010, data network (DN) 1030, and to external systems (not shown). Hardware 1001 executes hardware drivers 1002, operating systems 1003, virtual layer 1004, and network entity software 1005 to form MME 931, SGW 934, PGW 935, PCRF 933, and HSS 932.

FIG. 11 illustrates computing device 1101 that is representative of any system or collection of systems in which the various processes, programs, services, and scenarios disclosed herein may be implemented. Examples of computing device 1101 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 1101 may be implemented as a single apparatus, system, or device or may be implemented in a distributed manner as multiple apparatuses, systems, or devices. Computing device 1101 includes, but is not limited to, processing system 1102, storage system 1103, software 1105, communication interface system 1107, and user interface system 1109 (optional). Processing system 1102 is operatively coupled with storage system 1103, communication interface system 1107, and user interface system 1109.

Processing system 1102 loads and executes software 1105 from storage system 1103. Software 1105 includes and implements restoration process 1106, which is (are) representative of the call control function restoration processes discussed with respect to the preceding Figures, such as processes 200, 400, and 600. When executed by processing system 1102, software 1105 directs processing system 1102 to operate as described herein for at least the various processes, operational scenarios, and sequences discussed in the foregoing implementations. Computing device 1101 may optionally include additional devices, features, or functionality not discussed for purposes of brevity.

Referring still to FIG. 11, processing system 1102 may comprise a micro-processor and other circuitry that retrieves and executes software 1105 from storage system 1103. Processing system 1102 may be implemented within a single processing device but may also be distributed across multiple processing devices or sub-systems that cooperate in executing program instructions. Examples of processing system 1102 include general purpose central processing units, graphical processing units, application specific processors, and logic devices, as well as any other type of processing device, combinations, or variations thereof.

Storage system 1103 may comprise any computer readable storage media readable by processing system 1102 and capable of storing software 1105. Storage system 1103 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1103 may also include computer readable communication media over which at least some of software 1105 may be communicated internally or externally. Storage system 1103 may be implemented as a single storage device but may also be implemented across multiple storage devices or sub-systems co-located or distributed relative to each other. Storage system 1103 may comprise additional elements, such as a controller, capable of communicating with processing system 1102 or possibly other systems.

Software 1105 (including restoration process 1106) may be implemented in program instructions and among other functions may, when executed by processing system 1102, direct processing system 1102 to operate as described with respect to the various operational scenarios, sequences, and processes illustrated herein. For example, software 1105 may include program instructions for implementing a restoration process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1105 may include additional processes, programs, or components, such as operating system software, virtualization software, or other application software. Software 1105 may also comprise firmware or some other form of machine-readable processing instructions executable by processing system 1102.

In general, software 1105 may, when loaded into processing system 1102 and executed, transform a suitable apparatus, system, or device (of which computing device 1101 is representative) overall from a general-purpose computing system into a special-purpose computing system customized to support call control function restoration in an optimized manner. Indeed, encoding software 1105 on storage system 1103 may transform the physical structure of storage system 1103. The specific transformation of the physical structure may depend on various factors in different implementations of this description. Examples of such factors may include, but are not limited to, the technology used to implement the storage media of storage system 1103 and whether the computer-storage media are characterized as primary or secondary storage, as well as other factors.

For example, if the computer readable storage media are implemented as semiconductor-based memory, software 1105 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1107 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1101 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words "comprise," "comprising," “such as,” and “the like” are to be construed in an inclusive sense, as opposed to an exclusive or exhaustive sense, that is to say, in the sense of "including, but not limited to.” As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for," but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating a wireless network comprising:
by a session manager of the wireless network:
establishing an Internet Protocol Multimedia Service (IMS) registration of a user equipment (UE) for network service hosted by an IMS core of the wireless network, wherein the network service is anchored by a call controller;
receiving, from IMS core, a request for an assignment of a new call controller for the IMS registration;
in response to the request, performing an update of a cache of call controllers; and
establishing a new network session for the IMS registration on the wireless network, wherein the new network session is anchored by the new call controller from the updated cache of call controllers.

2. The method of claim 1, wherein performing the update of the cache of call control functions comprises querying a datastore for references to available call controllers prior to an expiration of a current instance of the cache of call controllers.

3. The method of claim 2, wherein the references to the available call controllers comprises an exclusion of a reference to the call controller of the IMS registration, wherein the exclusion is based on detecting, by the datastore, an absence of communication from the call controller.

4. The method of claim 1, wherein establishing the new network session for the IMS registration comprises sending, to the UE, a list of available call controllers from the updated cache of call controllers.

5. The method of claim 4, wherein the list of the available call controllers does not include the call controller.

6. The method of claim 1, wherein receiving the request for the assignment of the new call controller comprises receiving the request from a subscriber database of the wireless network based on the subscriber database receiving, from the IMS core, a request to update the assignment of the call controller of the IMS registration.

7. The method of claim 1, wherein the call controller comprises a Proxy Call Session Control Function (P-CSCF) of the IMS core.

8. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
establishing an Internet Protocol Multimedia Service (IMS) registration of a user equipment (UE) for network service anchored by a call controller of an IMS core of a wireless network;
receive, from IMS core of the wireless network, a request for an assignment of a new call controller for the IMS registration;
in response to receiving the request, perform an update of a cache of call controllers; and
establish a new network session for the UE on the wireless network, wherein the new network session is anchored by the new call controller from the updated cache of call controllers.

9. The computing apparatus of claim 8, wherein to perform the update of the cache of call control functions, the program instructions direct the computing apparatus to query a datastore for references to available call control functions prior to an expiration of a current instance of the cache of call controllers.

10. The computing apparatus of claim 9, wherein the references to the available call controllers comprises an exclusion of a reference to the call controller of the IMS registration, wherein the exclusion is based on detecting, by the datastore, an absence of communication from the call controller.

11. The computing apparatus of claim 8, wherein to establish the new network session for the IMS registration, the program instructions direct the computing apparatus to send, to the UE, a list of available call controllers from the updated cache of call controllers.

12. The computing apparatus of claim 11, wherein the list of available call controllers does not include a call controller.

13. The computing apparatus of claim 8, wherein to receive the request for the assignment of the new call controller, the program instructions direct the computing apparatus to receive the request from a subscriber database of the wireless network based on the subscriber database receiving, from the IMS core, a request to update the assignment of the call controller of the IMS registration.

14. The computing apparatus of claim 8, wherein the call controller comprises a Proxy Call Session Control Function (P-CSCF) of the IMS core.

15. The computing apparatus of claim 8, wherein the computing apparatus comprises a Session Management Function (SMF) of the wireless network.

16. A method of operating a wireless network comprising:
establishing an Internet Protocol Multimedia Service (IMS) registration of a user equipment (UE) for network service anchored by a call controller of an IMS core of the wireless network
receiving, from the IMS core of the wireless network, a request to update an assignment of a call controller of the IMS registration for the UE;
in response to the request, querying a datastore for available call controllers;
updating of a cache of call controllers based on the query; and
establishing a new network session for the UE on the wireless network anchored by the call controller from the updated cache of call controllers.

17. The method of claim 16, wherein receiving the request to update the assignment of the call controller comprises receiving the request from a subscriber database of the wireless network based on the subscriber database receiving, from the IMS core, a second request to update the assignment of the call controller of the IMS registration.

18. The method of claim 16, wherein receiving the request to update the assignment of the call controller comprises receiving, from a mobility manager of the wireless network, an indication to update the cache of call controllers in a request to delete a current network session of the IMS registration.

19. The method of claim 16, further comprising:
sending, to the UE, a request to establish the new network session, wherein the request includes a list of available call controllers from the updated cache of call controllers.

20. The method of claim 16, wherein updating the cache of the call controllers comprises querying a datastore for references to available call controllers prior to an expiration of a current instance of the cache of call controllers.
